(19) United States
(12) Patent Application Publication
(10) Pub. No.: US 2014/0142871 A1
(43) Pub. Date: May 22, 2014

(54) VIBRATION MONITORING SYSTEM

(71) Applicants: Clemens Lombriser, Thalwil (CH); Wolfgang H. Schott, Rueschlikon (CH); Brat E. Weiss, Edlibach (CH)

(72) Inventors: Clemens Lombriser, Thalwil (CH); Wolfgang H. Schott, Rueschlikon (CH); Brat E. Weiss, Edlibach (CH)

(73) Assignee: International Business Machines Corporation

(21) Appl. No.: 14/128,679

(22) PCT Filed: Jun. 5, 2012
(86) PCT No.: PCT/IB2012/052811

§ 371 Date: Dec. 23, 2013

(30) Foreign Application Priority Data
Jun. 28, 2011 (EP) 11171732.8

(51) Int. Cl. G01N 29/04; G01H 1/00

(52) U.S. Cl. CPC G01N 29/04; G01H 1/00
USPC 702/56; 73/584

(57) ABSTRACT

The invention is directed to a method for monitoring vibrations to detect distinct vibration events in an acceleration waveform converted into acceleration samples. The method comprises: storing the acceleration samples as a sequence of acceleration frames into a cache memory (S110); detecting the presence or absence of a distinct vibration event in each of said acceleration frames (S160); in case of detecting a distinct vibration event in an acceleration frame, forwarding said acceleration frame from said cache memory to a long-term storage device (S170).

### FIELD OF THE INVENTION

The invention relates to a method and device for measuring and digitally processing a vibration sensor signal. Especially, the invention is related to a low-power wireless vibration analysis sensor system to monitor for vibration damage to buildings according to DIN 4150-3.

### BACKGROUND

The standard of the German Institute for Standardization DIN 4150-3 “Vibration in buildings—Part 3: Effects on structures” defines a method to measure and assess vibrations on buildings and recommends thresholds below which vibrations can be considered not harmful for different classes of buildings, such as industrial, residence, and old or bad structural states.

Existing systems for this task usually consist of a data logger to which one or multiple sensing devices, usually geophones, are connected. This data logger may be used for measurements until the on-board memory is filled, upon which the measurement is terminated.

Some data loggers have integrated functions to trigger recordings for a certain amount of time. Other systems may be wireless, but often transmit their recorded data in bulk, requiring much bandwidth and transferring much information that is of no interest to the monitor, hence requiring considerable energy and thus resulting in a short system lifetime.

Some vibration sensing systems are designed for low-power wireless communication and also perform different signal processing functions. Those usually use microcontrollers for processing, which allow only a limited complexity of algorithms or require extended computation times, hence not allowing low-power operation or continuous monitoring. One such example is described in the document US 2008/0082296 A1.

Other devices with wireless communication and vibration sensors employ field-programmable gate arrays (FPGA) for filtering, such as the one presented in “Development of a smart wireless sensing unit using off-the-shelf FPGA hardware and programming products, in Smart Structures and Systems, Vol. 3(1), 2007”, or the one presented in “Development of wireless smart sensor for structural health monitoring, Proceedings SPIE, 2005”. However, these devices do not generate events, but rather describe distributed signal processing algorithms. Additionally, they do not include special functionality for long-term monitoring of damage to buildings.

Therefore, there is a need for an improved method and device for processing a vibration signal.

### BRIEF SUMMARY OF THE INVENTION

According to a first aspect, the invention is embodied as a method for monitoring vibrations to detect distinct vibration events in an acceleration waveform converted into acceleration samples. The method comprises:
storing the acceleration samples as a sequence of acceleration frames into a cache memory;
detecting the presence or absence of a distinct vibration event in each of said acceleration frames;
in case of detecting a distinct vibration event in an acceleration frame, forwarding said acceleration frame from said cache memory to a long-term storage device.

In embodiments, the method may comprise one or more of the following features:
each of said acceleration frames has a fixed length and wherein each of said acceleration frames comprises several frames stored in said cache memory;
the method further comprises the steps of computing velocity frames from said acceleration frames stored in said cache memory, computing velocity parameters for each of said velocity frames, wherein the detecting step comprises detecting the presence or absence of distinct vibrations in each of said velocity frames computed from said acceleration frames based on the computed velocity parameters;
the step of storing said velocity parameters for each of said velocity frames to said long-term storage device;
the long-term storage device is a memory comprising a first address space and a second address space, and wherein said acceleration frame is forwarded from said cache memory to the first address space of the memory in case of detecting a distinct vibration event and said velocity parameters of each said velocity frames are stored to the second address space of the memory;
said velocity frames are computed from said acceleration frames by computing a mean value of said acceleration frames using a forward Euler integration, and integrating DC-offset compensated acceleration frames using a backward Euler integration;
velocity parameters for each of said velocity frames are the maximum absolute vibration velocity |vᵢ|ₘₐₓ of each said velocity frame within a window of a length W, where W is smaller than or equal to the length of a velocity frame, the position tᵢ^{s} of said maximum absolute vibration velocity |vᵢ|ₘₐₓ thin said window of length W, the dominant frequency fᵢ of each said velocity frames;
the step of constructing windowed velocity frames of length W by shifting the velocity samples of each velocity frame so that the velocity sample with maximum absolute vibration velocity |vᵢ|ₘₐₓ in the centre of said window of length W, and dropping the velocity samples of each velocity frame outside said window of length W;
said dominant frequency fᵢ of each said velocity frame is detected by computing the magnitude of the frequency spectrum of each said windowed velocity frame of length W using a real-value W-point Bruun Fast Fourier Transform, and searching for the frequency index which maximizes the magnitude of said frequency spectrum;
the magnitude of the frequency spectrum is computed by using the law of cosines in the last stage of said real-value W-point Bruun Fast Fourier Transform;
the computation of the magnitude of the frequency spectrum using said real-value W-point Bruun Fast Fourier Transform further comprise comprises multiplying said windowed velocity frame of length W with a filter window function w of size W, storing the result of the multiplication of said windowed velocity frame of length W and said window function w of size W, and simultaneously computing the first stage of the Bruun Fast Fourier Transform;
the detection of said dominant frequency fᵢ further comprises the step of prescaling the velocity samples of each said windowed velocity frame of length W by bit-shifting such that the maximum absolute vibration velocity max |vᵢ|ₘₐₓ represented by the maximum valid digital number wherein the presence of a distinct vibration event is detected in each of said velocity frames by comparing said maximum absolute vibration velocity |vᵢ|ₘₐₓ to a predefined threshold value vₜₕ(fᵢ), and detecting an event if said maximum absolute vibration velocity |vᵢ|ₘₐₓ exceeds said threshold value vₜₕ(fᵢ).

According to another aspect, the invention is embodied as apparatus for monitoring vibrations to detect distinct vibration events, wherein the apparatus is configured for performing all the steps of the method of the invention.

### BRIEF DESCRIPTION OF THE DRAWINGS

A system and a method embodying the invention will now be described, by way of non-limiting examples, and in reference to the accompanying drawings, where:

FIG. 1 is a flowchart describing an embodiment of the invention;

FIG. 2 is a diagram detailing components of an apparatus for monitoring vibrations according to the invention;

FIG. 3 is a diagram showing a possible organization of a cache memory and a long-term storage device;

FIG. 4 is a schematic diagram illustrating an integration module to obtain a velocity signal from an acceleration signal;

FIG. 5 is a schematic diagram of a dominant frequency detection module;

FIG. 6 is a schematic diagram of a detection module;

FIG. 7 is a schematic diagram of a possible wireless vibration sensor network comprising one or more devices for monitoring vibrations according to the invention.

### DETAILED DESCRIPTION OF THE EMBODIMENTS

The invention describes a method for monitoring vibrations and detecting vibrations exceeding given thresholds, for example the ones stated in DIN 4150-3 for limits of vibration on building structures. A vibration is first transformed into an acceleration waveform that is then converted from an analog continuous quantity to a discrete time digital representation. These acceleration samples form acceleration frames from which a number of velocity parameters are determined. Acceleration frames are stored in a cache memory. A cache memory is a memory which serves as temporary storage. For each acceleration frame, the velocity parameters are saved to a long-term storage device, thus creating a continuous stream of velocity parameters. The method further compares the velocity parameters to a configurable threshold function, e.g. defined by DIN 4150-3. In case the threshold function is exceeded, the acceleration frame corresponding to the event is also forwarded to a long-term storage device. Forwarding means that the acceleration data is moved from the cache memory to the long-term storage device. A long-term storage device is able to store a larger amount of data compared to the cache memory. The long-term storage device may be an external memory, that is, a memory distinct from the cache memory. Advantageously, the acceleration frame can be provided upon later request for a possible more detailed analysis. Favorably, a device for monitoring vibration is designed for low-power operation allowing continuous vibration monitoring over several months from a single battery.

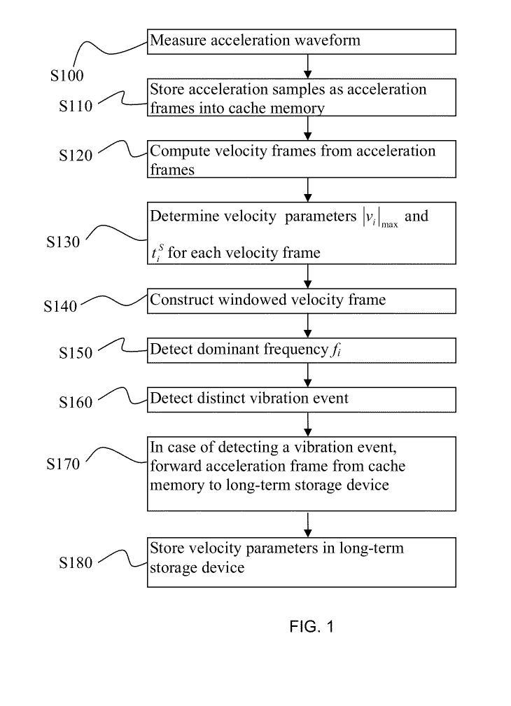

In reference to FIG. 1, at step S100, acceleration samples are acquired for further analysis. In practice, a vibration is transformed by an acceleration sensor into an acceleration waveform that may be sampled and filtered into a sequence of acceleration samples. The vibration may be transformed to independent waveforms corresponding to three orthogonal axes x, y, and z. The vibration signals may be pre-processed in parallel by a data acquisition unit to obtain the filtered acceleration signals aᵢ(k), where i indicates one of the axes x, y, or z.

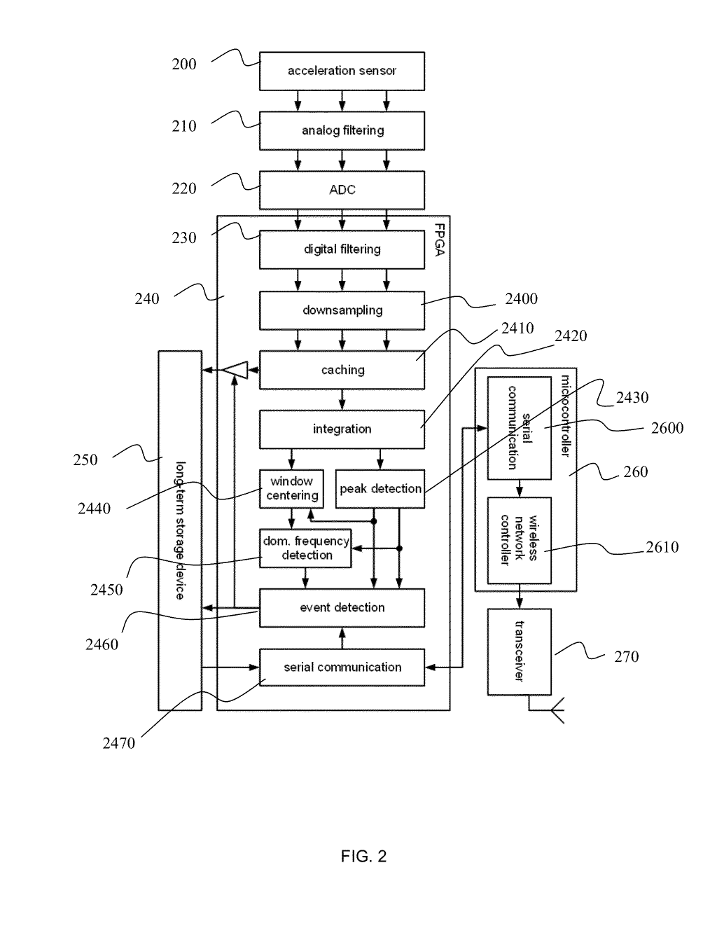

The data acquisition step S100 may be divided into five steps respectively carried out by dedicated modules, as illustrated in FIG. 2: an acceleration sensor 200 providing an analog acceleration waveform, an analog filter 210 for filtering the acceleration waveform, an analog-to-digital converter (ADC) 220 for sampling the acceleration waveform into a stream of digital acceleration samples, a digital filter 230 for filtering the acceleration samples, and a downsampler 2400 for downsampling the filtered acceleration data.

For instance, the data acquisition unit may acquire acceleration waveforms for each axis x, y, and z with a dynamic range of ±2 g and a resolution of 0.5 mg. The vibration signals may be detected by a sensor device consisting of a Microelectromechanical systems (MEMS) acceleration sensor. Each of the acceleration waveforms may be filtered with an individual low pass 210 with a 3 dB cut-off frequency of 128 Hz. Then, the vibration waveform may be sampled with a 16-bit analog-to-digital converter (ADC) 220 at a rate of 2,048 kHz. The acceleration samples may then be temperature compensated before further processing. A digital filter 230 may implement a third order Butterworth filter with a 3 dB cut-off frequency of 128 Hz that advantageously reinforces the analog filter before the signal is downsampled to a 256 Hz signal by a downsampler 2400.

It is to be understood that the different acquisition acceleration waveforms x, y, and z from the sensors may be handled in parallel, i.e. for each channel, separate filters are used.

The division of the low-pass filter into an analog and digital part advantageously allows reducing the number of physical components required for the embodiment of the invention, thus facilitating the implementation, and saving costs. The logic may be transferred into a programmable and configurable integrated circuit such as a field-programmable gate array (FPGA) 240.

Referring back to FIG. 1, at step S110, the acceleration samples acquired from vibration signals are stored as a sequence of acceleration frames into a cache memory 2410. The cache memory may be integrated in the FPGA 240. This reduces the number of physical components required for the embodiment of the invention. The acceleration frames may have a fixed length, that is, each acceleration frame may comprise a number of acceleration samples. In addition, the acceleration frame may span several frames stored in said cache memory.

Then, at steps S120 to S160, the cached acceleration samples are processed for detecting the presence or the absence of a distinct vibration event. This may be done by testing whether a set of signal parameters exceed a threshold function. To this aim, the filtered and sampled acceleration samples are segmented into overlapping acceleration frames and further processed in an integration unit 2420, peak detection unit 2430, and dominant frequency detection unit 2450, as illustrated in FIG. 2. Due to increased resource needs for these operations, they may be performed in a time-multiplexed way on the acceleration frames of the different axes, thus only requiring a single implemented unit 2420, 2430, and 2450. For each axis and acceleration frame, three velocity parameters are computed: the peak velocity |vᵢ|ₘₐₓ (also referred to as a maximum absolute velocity), its time index tᵢ^{s} (also referred to as the position or index of the maximum absolute vibration within the frame being analyzed), and the dominant frequency fᵢ. The parameter values are collected by the event detection module 2460, which compares each set to a threshold function, e.g. a threshold function derived from DIN 4150-3. In case the values of any axis exceed the threshold function, an event is considered detected.

At step S120, a velocity frame is computed from the acceleration frame retrieved from the cache memory. The computation of the velocity frame may be carried out by first computing the mean velocity value of the acceleration frame using forward Euler integration, then subtracting said mean velocity value within a second backward Euler integration to obtain a DC-offset compensated velocity frame. The velocity frame is computed for an acceleration frame comprising a number of acceleration samples F. The step S120 may be performed by the integration unit 2420 illustrated on FIG. 2. The computed velocity frame v(k) may then be used for successive steps S130 and S140.

In practice, the acceleration data of an individual axis is integrated to determine the velocity parameters |vᵢ|ₘₐₓ, tᵢ^{s}, and fᵢ. For the analysis, the integration unit retrieves an acceleration frame from the cache memory. For instance, an acceleration frame may comprise F=512 acceleration samples. If the sampling period T is selected such that T= 1/256 seconds, then an acceleration frame comprising 512 acceleration samples represents the acceleration signal of two seconds. Subsequent frames may overlap by half a frame size, i.e. one second.

FIG. 4 shows an example of a circuit able to perform the integration step S120. This example circuit may be implemented on a programmable and configurable integrated circuit such as the FPGA 240 of FIG. 2.

For the integration, a DC offset compensation circuit first computes a mean value

$$\overline{{v}_{f}} = \frac{1}{F} \sum {v}_{f} ( k )$$

over the frame F using forward Euler integration v_{f}(k+1)=v_{f}(k)+T·a(t), where T is the sample period (e.g. T= 1/256 s). The mean velocity value is used to compute a DC offset free velocity signal through a backward Euler integration v(k+1)=v(k)+T·a(k+1)− v̅_̅{̅f̅}̅.

Advantageously, using forward Euler integration for computing the DC offset v̅_̅{̅f̅}̅ and backward Euler integration for the final integration reduces the overall integration error.

The dynamic range of the integrator may be extended to 18 bits, further, the accumulator may saturate due to under- or over-flow, which is indicated to the event detector, such that it can handle it in compliance with DIN 45669-1 describing requirements for devices used for performing measurements according to DIN 4150-3.

Next, at steps S130 of FIG. 1, two velocity parameters of the velocity frame v(k) are computed. The velocity parameters characterize the sensed vibration or the distinct vibration events in an acceleration waveform. A first velocity parameter is the maximum absolute vibration velocity |vᵢ|ₘₐₓ and is computed for each velocity frame within a window of a length W, where W is smaller than or equal to the length of a velocity frame. In practice, the maximum absolute vibration velocity |vᵢ|ₘₐₓ is computed for each velocity frame integrated from the acceleration frame at step S120. |vᵢ|ₘₐₓ is only searched within the middle of the velocity frame; for instance, if the velocity frame of two seconds comprises 512 samples, then the maximum velocity is computed within the 256 samples in the centre, i.e. [128, 383]. Once the maximum observed velocity |vᵢ|ₘₐₓ is found, a second velocity parameter follows automatically: the time index tᵢ^{s} is the position of the maximum absolute vibration velocity |vᵢ|ₘₐₓ within the window of length W. In practice, tᵢ^{s} corresponds to the sample index of |vᵢ|ₘₐₓ within the velocity frame, such that tᵢ^{s} ε[128, 383]. The parameters |vᵢ|ₘₐₓ and tᵢ^{s} may be computed by the peak detection unit 2430 in FIG. 2.

Next, at step S140, a window of length W centered at tᵢ^{s} is extracted from the velocity frame. This may be carried out by shifting the velocity values of each velocity frame such that the maximum absolute vibration velocity |vᵢ|ₘₐₓ is in the centre of said window of a length W and by dropping all velocity values of each velocity frame that are outside said window of a length W. For instance, a window of size W=256 can be extracted from the velocity frame of step S130 by selecting the velocity values [tᵢ^{s}−128, tᵢ^{s}+127]. The windowed velocity frame v′(k) is then forwarded to the dominant frequency detection unit.

The centered window may be computed by the window centering unit 2440 of FIG. 2.

Next, step S150 determines the dominant frequency fᵢ of the windowed velocity frame v′(k). The dominant frequency fᵢ may be detected by the dominant frequency detection unit 2450 of FIG. 2.

An example of a dominant frequency detection unit is represented in FIG. 5. The unit is used to compute a modified fully real-valued Fast Fourier Transform (FFT) after Bruun (G. Bruun, z-Transform DFT Filters and FFT's, IEEE Trans. Acoustics, Speech, and Signal Processing, Vol. 26(1), 1978) also referred to as Bruun FFT. For a signal with W=256 samples, the FFT can be computed in S=log₂(W)=8 stages.

The standard Bruun FFT defines a sequence of operations using the Butterfly depicted within FIG. 5 to compute the FFT of the windowed velocity frame v′(k). Within one iteration, three values are obtained from a memory, processed by the Butterfly unit, then stored back to memory. A FFT stage is completed after all values stored within the memory have been updated at least once, hence after N/2 iterations. This invention modifies how the input values are initially read into the memory and how the first and last stage of the Bruun FFT are performed. The remaining stages are performed as usual and hence not further described.

The first modification of the implementation of the standard Bruun FFT comprises a prescaling of the velocity values of each windowed velocity frame of length W: when reading in the windowed velocity frame v′(k), the values are prescaled by bitshifting all incoming values arithmetically left by 18−ceil(log₂(|vᵢ|ₘₐₓ)), where ceil is a function rounding a real number up to the next integer. This way, the maximum absolute vibration velocity is represented by the maximum valid digital number specified for an input signal in the dominant frequency detection unit. This advantageously allows to ensure the maximum value uses the most significant bits and reduces the bitwidth required for internal computation.

The second modification of the implementation combines the multiplication of a window function w(k) with storing the incoming windowed velocity frame v′(k) into memory and simultaneously computing the first stage of the Bruun FFT. The window function w(k) may implement a Hamming window. All calculations are performed using the Bruun FFT Butterfly unit as shown in FIG. 5. The first incoming W/2 velocity values are multiplied by the corresponding value of the window function w(k). This may be done using the Butterfly unit's multiplicator on the windowed velocity frame v′(k) and the corresponding entry in the window function table, while setting the summand inputs to the Butterfly unit to zero. The output of the positive branch of the Butterfly is then stored into a memory as v″(k)=w(k)·v′k; for instance the memory represented on FIG. 5.

While reading in the second W/2 velocity values of the windowed velocity frame v′(k), the first stage of the Bruun FFT on the previously stored first W/2 values of v″(k) can be performed simultaneously to the multiplication with the window function and the first stage of the Bruun FFT on the second incoming W/2 velocity values. The results of the first Bruun FFT stage f₁(k) and

$${f}_{1} ( k - \frac{W}{2} )$$

can be computed with the relations

$${f}_{1} ( k ) = {v}^{″} ( k - \frac{W}{2} ) - {v}^{″} ( k )$$

$$and$$

$${f}_{1} ( k - \frac{W}{2} ) = {v}^{″} ( k - \frac{W}{2} ) + {v}^{″} ( k ) .$$

Using the multiplication of the Butterfly unit to multiply the shifted incoming windowed velocity frame v′(k) with the corresponding window function factor w(k), setting one of the summands equal to the previously stored value

$${v}^{″} ( k - \frac{W}{2} )$$

and the other to zero, the Butterfly unit will produce

$${f}_{1} ( k ) = {v}^{″} ( k - \frac{W}{2} ) + w ( k ) \cdot {v}^{′} ( k )$$

$$and$$

$${f}_{1} ( k - \frac{W}{2} ) = {v}^{″} ( k - \frac{W}{2} ) - w ( k ) \cdot {v}^{′} ( k )$$

as its outputs.

The third modification of the implementation relies on that, in the last stage of the original Bruun FFT, the real and imaginary components of the complex FFT are computed. For the detection of the dominant frequency however only the magnitude is needed. The Bruun FFT defines in the last stage S a multiplication

$${f}_{S} = {f}_{S - 1} ( m ) \cdot exp ( j \frac{2 π}{N} k ) + {f}_{S - 1} ( n )$$

to determine the complex result, where m and n are the indexes of the values of the previous stage as in the standard Bruun FFT procedure. The magnitude could then be computed by summing up the squares as in |fₛ(k)|²=Re(fₛ(k))²+Im(fₛ(k))². The invention uses the Butterfly unit and the cosine table also used by the other Bruun FFT stages to compute the magnitude directly using the law of cosines:

$$\begin{matrix}{\vert {f}_{S} ( k ) \vert}^{2} = {f}_{S - 1}^{2} ( m ) + {f}_{S - 1}^{2} ( n ) - {f}_{S - 1} ( m ) {f}_{S - 1} ( n ) cos ( π - \frac{2 π}{N} k ) \\ = {f}_{S - 1} ( m ) \cdot ( {f}_{S - 1} ( m ) + {f}_{S - 1} ( n ) cos ( \frac{2 π}{N} k ) ) + {f}_{S - 1}^{2} ( n )\end{matrix}$$

Using the law of cosines allows computing the magnitude in 3 steps using the available butterfly and thus no additional hardware is required. In the first step

$${f}_{S - 1} ( m ) + {f}_{S - 1} ( n ) cos ( \frac{2 π}{N} k )$$

is computed using the corresponding cosine table entry and fₛ₋₁(n) as multiplicants, zero as first, and f₇(m) as second summand. As a second step, fₛ₋₁²(n) can be computed by setting the multiplicants both to fₛ₋₁(n) and the summands to zero. In a third step, the output of the first step is multiplied by fₛ₋₁ (m), the first summand is set to zero, and the second to the output of the second step.

The maximum frequency magnitude m_{f} can be found by setting m_{f} initially to zero, and iteratively compare it to the output of the third magnitude computation step. In case a larger magnitude is found, the value m_{f} is set to this new maximum and its index is stored. After having computed all |fₛ(k)|², the index then contains

$${f}_{i} = {max}_{i} {\vert {f}_{S} ( k ) \vert}^{2} ,$$

which is passed to the event detection unit as dominant frequency of the windowed velocity frame of the current axis i.

From now, the velocity parameters

$${\vert {v}_{i} \vert}_{max} , {t}_{i}^{S} ,$$

and fᵢ have been computed for all axes i.

Next, at step S160, it is determined whether or not the window W′ comprises a distinct vibration event, that is, whether the velocity parameters exceed a threshold function. The detection may be performed by an event detection unit 2460 as depicted on FIG. 2.

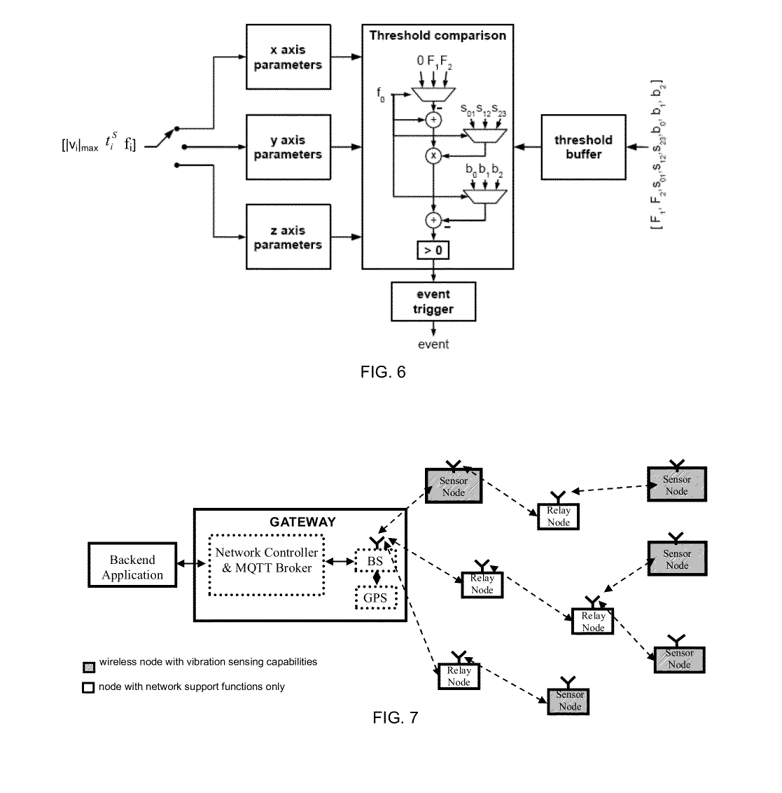

Referring now to FIG. 6, a possible embodiment of an event detection unit is described. The event detection unit compares the velocity parameters computed for each axis individually against a configurable threshold function vₜₕ(f) as defined for instance by DIN 4150-3. The threshold function vₜₕ(f) may be defined as a piecewise linear function and characterized through two frequency parameters F₁ and F₂, three slope parameters s₀₁, s₁₂, and s₂₃, and three offsets b₀, b₁, and b₂:

$${v}_{th} ( f ) = \{ \begin{matrix}f \cdot {s}_{01} - {b}_{0} & if & f < {F}_{1} , \\ ( f - {F}_{1} ) \cdot {s}_{12} & if & {F}_{1} \leq f < {F}_{2} , \\ ( f - {F}_{2} ) \cdot {s}_{23} & if & {F}_{2} < f ,\end{matrix}$$

An event is triggered if for any axis the condition vₜₕ(fᵢ)−|vᵢ|ₘₐₓ≦0 is met. In such a case, the event detection unit generates an additional signal parameter eₓ=1, e_{y}=1, or e_{z}=1. An example frequency parameter set for residential buildings after DIN 4150-3 is [F₁=10 Hz; F₂=50 Hz; s₀₁=0 mm; s₁₂=0.25 mm; s₂₃=0.125 mm; b₀=5 mm/s; b₁=5 mm/s; b₂=15 mm/s].

Referring now to step S170, the acceleration frame from which a distinct vibration event is detected at step S160 may be forwarded from the cache memory to a long-term storage device in case an event is detected. In other words, in case an event is triggered, the corresponding filtered acceleration samples of all axes are written to the long-term storage device.

Next, at step S180, the velocity parameters of all axes together with the events and a frame index that is incremented after having processed the acceleration frames are stored in the long-term storage device.

It is to be understood that the step S170 may also be performed after the step S180, or both steps S170 and S180 may be concurrently performed.

Therefore, the acceleration data acquired at step S100 is stored within a cache memory for further processing, and moved to the long-term storage device in case of detecting a vibration event. The long-term storage device is a dedicated memory used to extend the cache available and to allow the device to operate for several hours autonomously, while saving all relevant generated data. The relevant data consist of a continuous sequence of computed velocity parameters, window indices, and filtered acceleration data windows of detected events.

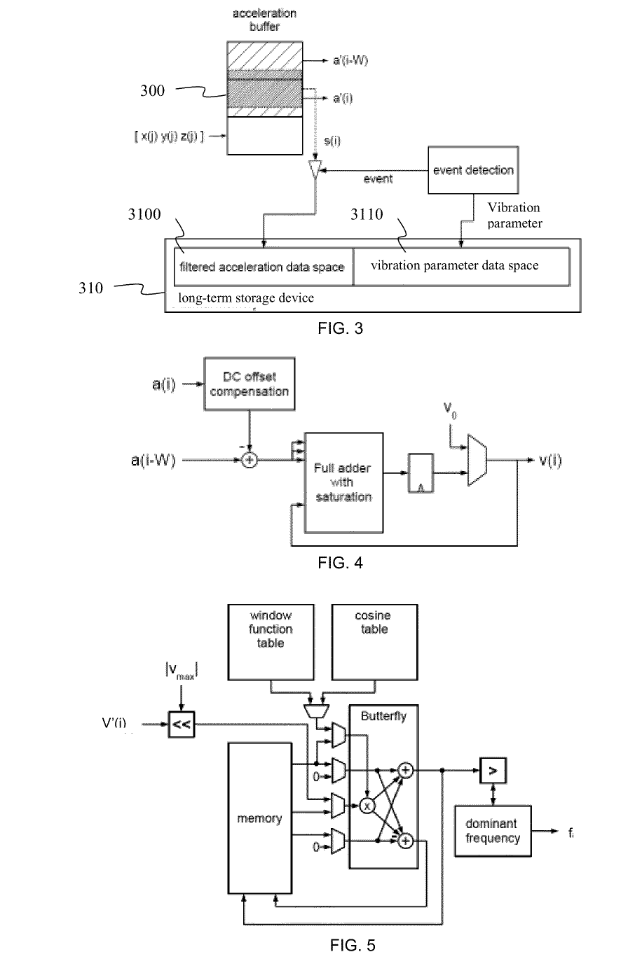

Referring now to FIG. 3, a possible organization of the cache memory and the long-term storage device is shown. In FIG. 3, the cache 300 receives three acceleration data streams for each axis x, y, and z of a vibration signal. The cache memory is organized into a ring buffer and provides at least three buffer frames for storing of a number of successive acceleration samples corresponding to the window size W. For instance, if the sampling period T is selected such that T= 1/256 seconds, then a frame can store 256 consecutive acceleration samples. The acceleration data for each axis x, y, and z is written into the cache in parallel, while the subsequent signal processing unit retrieves them sequentially. The cache must retain the acceleration samples at least until the event detection unit has determined whether it contains a distinct vibration event or not. If an event has been detected, the cache forwards the data to a long-term storage device. The long-term storage device may be implemented within the FPGA or as a separate memory device. Referring to FIG. 2, the cache memory may be implemented on the FPGA 240 while the long-term storage device is implemented on a separate memory device.

Back to FIG. 3, the long-term storage device 310 is divided into two address spaces; one for the velocity parameters 3110, and one 3100 for the acceleration frames from which an event is detected. Advantageously, the proportions of those address spaces may be chosen depending on the frequency of events expected. In case many events or events of longer duration are expected, the acceleration frame data space can be chosen larger, leaving less room for signal parameter storage. The management of the address spaces may therefore be performed according to expected events to be detected.

In practice, the long-term storage device 310 has larger storage capabilities than the cache memory 300, which provides two advantages. First, more event data (acceleration data 3100 and velocity parameters 3110) can be stored and kept until it is requested by a monitor. This is important for longer bursts of vibrations generating events, such as during an earthquake. Second, the computed velocity parameters may be stored to this device as well, which allows for several hours of storage until they may be retrieved by the monitor. This ensures continuous monitoring, even if the monitoring device is disconnected for several hours.

The method according to the invention may be implemented within a sensor device to be used within a wireless network of the same sensors for distributed detection of vibration events. Each sensor device autonomously acquires acceleration data, integrates it to determine the velocity of the vibration, determines the velocity signal parameters, and communicates those parameters through a wireless network to a remote monitor. The velocity parameters are delivered in a reliable transmission to allow for uninterrupted monitoring.

In case the thresholds are exceeded, the corresponding acceleration signal is stored and may at a later point be provided upon request received through the network. Advantageously, the network may optimize for low-rate periodic signal parameter transmissions and implement a dedicated method to transmit the acceleration signal as a burst from a limited set of nodes.

The method according to the invention may be implemented within apparatus for monitoring vibrations to detect distinct vibration events, e.g. a sensor device as the one depicted on FIG. 2. The sensor device may consist of a MEMS acceleration sensor 200, analog circuitry to filter the vibration signal 210, an analog-to-digital converter to transform the vibration signal into a digital one 220, a FPGA 240 for signal processing the sampled vibration signal (230, 2400, 2420, 2430, 2440, 2450) and event detection 2460, a cache memory 2410 for storing or caching the acceleration data for processing, long term storage (e.g. a memory) 250 for storing velocity parameters and the raw acceleration data of events, a microcontroller 260 for controlling the wireless network, a low-power transceiver 270 for the wireless communication, and a battery for power supply (not represented).

The microcontroller 260 for controlling the wireless network may comprise a wireless network controller 2610 that may be in connection with a serial communications unit 2600 that is able to exchange data with the serial communication unit 2470 on the FPGA of the sensor device. In other terms, both serial communication units 2470 and 2600 access a common communication medium between the wireless network controller 2610 and the FPGA.

The wireless network controller 2610 may follow a network sleep and active schedule and decide upon the appropriate time to communicate one or more velocity signal parameters sets. When the wireless network controller 2610 requests data from the FPGA 240, synchronization of the FPGA and microcontroller 260 clock are performed. This synchronization allows to relate the time a measurement was taken to the network global time the microcontroller generates.

During its active phase, the microcontroller may at any time request the delivery of the signal parameters or acceleration data stored within the long-term storage, or reconfigures the threshold function. Upon such a request, the FPGA retrieves the data from the memory and may add its own synchronization information to enable the network controller to estimate the time of acquisition and relate it to the network global time reference. The data obtained from the FPGA may be forwarded by the network controller over the wireless network to some remote monitor.

The synchronization may be performed as follows. The microcontroller being the master of a Serial Peripheral Interface (SPI) communication 2470 and 2600 writes a byte to the FPGA, to which an FPGA synchronously writes a byte back. At the initiation of a transfer of velocity parameters, the FPGA may access an internal clock register when the microcontroller starts sending its SPI byte. This generates a timestamp that is taken close to the communication. After having received this byte, the microcontroller immediately accesses its own time register and stores this value. The intermediate time can be measured with high accuracy and is constant to a high degree.

During the communication, the FPGA may additionally transmit its current window index t, which is always incremented during the same known FPGA time value within a second. Relating a current frame index received with the velocity signal parameters and the timestamp of the reception allows an accurate relation to the network global time.

Referring now to FIG. 7, a wireless network comprising sensor devices according to an embodiment of the invention is depicted. Multiple wireless sensors may be combined into a low-power wireless network allowing synchronized measurements at multiple locations and reporting of continuous monitoring events as well as measured signals of damage events to a remote control station.

Several sensor nodes and relay nodes may form a network which communicates, possibly over multiple hops, to a base station (BS), which is connected to a gateway. A sensor node is a node having vibration signal sensing capabilities, and a relay node is a node having only network support function.

The base station may further be connected to a Global Positioning System (GPS) to synchronize the network time to a globally valid reference time. The base station may execute a network controller and a message broker, e.g. a MQTT (MQ Telemetry Transport) broker.

The broker may transmit information relative to the detected events to a remote monitor, e.g. a backend application that further analyses the transmitted information. This backend application may also send information to individual sensor nodes via the broker. The backend application may for instance configure the threshold function vₜₕ(f) used within a sensor node.

It is to be understood that even in the case of multiple hours of network failure, the information relative to the detected event can be safely stored into the long-term memory. Therefore, this strategy advantageously allows a reliable continuous monitoring even in the presence of extended wireless network failure. Furthermore, the wireless network of FIG. 7 may be replaced by a wired network.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a and/or block diagrams, can be implemented by computer program instructions. These computer program instructions may be provided to a processor of a general purpose computer, special purpose computer, or remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1. A method for monitoring vibrations to detect distinct vibration events, the method comprising:
storing acceleration samples as a sequence of acceleration frames into a cache
memory;
detecting a presence or an absence of a distinct vibration event in each of said acceleration frames; and
forwarding an acceleration frame from said cache memory to a long-term storage device in response to detecting the distinct vibration event in said acceleration frame.

2. The method of claim 1, wherein
each of said acceleration frames has a fixed length; and
each of said acceleration frames comprises several frames stored in said cache memory.

3. The method of claim 1, further comprising:
computing velocity frames from said acceleration frames stored in said cache memory; and
computing velocity parameters for each of said velocity frames;
wherein the detecting step comprises detecting the presence or the absence of distinct vibrations in each of said velocity frames computed from said acceleration frames based on the computed velocity parameters.

4. The method of claim 3, further comprising: storing said velocity parameters for each of said velocity frames to said long-term storage device.

5. The method of claim 4, wherein:
the long-term storage device is a memory comprising a first address space and a second address space;
said acceleration frame is forwarded from said cache memory to the first address space of the memory in response to detecting the distinct vibration event; and
said velocity parameters of each said velocity frames are stored to the second address space of the memory.

6. The method of claim 3, wherein said velocity frames are computed from said acceleration frames by a method comprising:
computing a mean value of said acceleration frames using a forward Euler integration; and
integrating DC-offset compensated acceleration frames using a backward Euler integration.

7. The method of claim 3, wherein velocity parameters for each of said velocity frames comprises:
the maximum absolute vibration velocity |vᵢ|ₘₐₓ of each said velocity frame within a window of a length W, where W is smaller than or equal to the length of a velocity frame;
the position tᵢ^{s} of said maximum absolute vibration velocity |vᵢ|ₘₐₓ within said window of length W; and
the dominant frequency fᵢ of each said velocity frames.

8. The method of claim 7, further comprising:
constructing windowed velocity frames of length W by a method comprising:
shifting the velocity samples of each velocity frame so that the velocity sample with maximum absolute vibration velocity |vᵢ|ₘₐₓ is in the centre of said window of length W; and
dropping the velocity samples of each velocity frame outside said window of length W.

9. The method of claim 8, wherein said dominant frequency fᵢ of each said velocity frame is detected by a method comprising:
computing the magnitude of the frequency spectrum of each said windowed velocity frame of length W using a real-value W-point Bruun Fast Fourier Transform; and
searching for the frequency index which maximizes the magnitude of said frequency spectrum.

10. The method of claim 9, wherein the magnitude of the frequency spectrum is computed by using the law of cosines in the last stage of said real-value W-point Bruun Fast Fourier Transform.

11. The method of claim 9, wherein the computation of the magnitude of the frequency spectrum using said real-value W-point Bruun Fast Fourier Transform further comprises:
multiplying said windowed velocity frame of length W with a filter window function w of size W;
storing the result of the multiplication of said windowed velocity frame of length W and said window function w of size W; and
computing simultaneously the first stage of the Bruun Fast Fourier Transform.

12. The method of claim 9, wherein the detection of said dominant frequency fᵢ further comprises the step of pre-scaling the velocity samples of each said windowed velocity frame of length W by bit-shifting so that the maximum absolute vibration velocity |vᵢ|ₘₐₓ is represented by the maximum valid digital number.

13. The method of claim 7, wherein the presence of the distinct vibration event is detected in each of said velocity frames by a method comprising:
comparing said maximum absolute vibration velocity |vᵢ|ₘₐₓ to a predefined threshold value vₜₕ(fᵢ); and
detecting an event if said maximum absolute vibration velocity |vᵢ|ₘₐₓ exceeds said threshold value vₜₕ(fᵢ).

14. The method of claim 1, wherein the cache memory is organized into a ring buffer and provides at least one buffer for storing the filtered acceleration samples as a sequence of acceleration frames.

15. An apparatus for monitoring vibrations to detect distinct vibration events, wherein the apparatus is configured for performing the steps of the method comprising:
an integration unit configured to store the acceleration samples as a sequence of acceleration frames into a cache memory;
a frequency detection unit configured to detect a presence or an absence of a distinct vibration event in each of said acceleration frames; and
an event detection unit configured to forward said acceleration frame from said cache memory to a long-term storage device in case of detecting a distinct vibration event in an acceleration frame.

16. A computer readable non-transitory article of manufacture tangibly embodying computer readable instructions which, when executed, causes a computer to carry out the steps of a method comprising:
storing acceleration samples as a sequence of acceleration frames into a cache memory;
detecting a presence or an absence of a distinct vibration event in each of said acceleration frames; and
forwarding said acceleration frame from said cache memory to a long-term storage device in case of detecting a distinct vibration event in an acceleration frame.
